(19) United States
(12) Patent Application Publication
(10) Pub. No.: US 2020/0319059 A1
(43) Pub. Date: Oct. 8, 2020

(54) TESTING APPARATUS FOR GEARS

(71) Applicant: GE AVIO S.R.L, Rivalta di Torino (IT)

(72) Inventors: Michele Gravina, Minervino Murge (IT); Guido Rocca, Livorno (IT)

(21) Appl. No.: 16/303,544

(22) PCT Filed: Jun. 2, 2017
(86) PCT No.: PCT/EP2017/063560

§ 371 Date: Nov. 20, 2018

(30) Foreign Application Priority Data
Jun. 9, 2016 (IT) 102016000059288

(51) Int. Cl. G01M 13/021; G01N 3/04

(52) U.S. Cl. CPC G01M 13/021; G01N 3/04

(57) ABSTRACT

A test apparatus for testing a gear has a clamping device for clamping the gear. The device includes a single support block having one passage, extending along an axis, and a transversal first shoulder. The device further includes a securing bolt having a second shoulder provided with a pin axially extending through the passage and with a tightening member tightened on the pin so as to axially clamp the gear between the two shoulders. The support block further has a fixed protrusion axially projecting with respect to the first shoulder and having an outer surface designed to carry the gear.

### TECHNICAL FIELD

The present invention relates to a test apparatus for testing gears, in particular a test apparatus for fatigue testing of gears.

### BACKGROUND OF THE DISCLOSURE

Gears have applications within transmission systems in different fields, as the automotive, the naval or the aeronautic fields.

Gears applied in aeronautical transmission systems have to satisfy extremely demanding reliability and durability requirements.

A common parameter for evaluating the reliability and durability of gears is the fatigue strength, which is estimated by means of fatigue tests performed on specific test rigs.

In the commonly known test rigs, the tested gear is clamped in a fixed position on a test apparatus and a force is applied onto the flank of one or more teeth of the gear by means of an actuator and a force transmission element which transfers the force from the actuator onto the above-mentioned flank.

As far as the clamping is concerned, a need is felt to avoid possible clearance at the zones where the gear is coupled to the test rig, so as to avoid undesired movements of the gear during the application of the force and therefore ensure the confidence of the test result. In particular, a reliable result would allow for the determination of absolute values of the resistance fatigue, and not only for comparison between the resistance values of different gears.

In some known solutions, the test rig has a clamping device including a fork element with two vertical arms supporting a horizontal shaft. The gear is mounted on such shaft and is housed in a gap defined by the two arms of the fork element. This kind of solution is rather unsatisfactory because it is rather difficult to ensure the clamping of the gear without axial clearance between the arms of the fork element and the gear. Additionally, the clamping device having a fork element leads to undesired radial clearance.

Another known test rig for testing gears is disclosed in FIG. 2 of FR-A-2878330, which corresponds to the preamble of claim 1. The test rig has a single support block carrying the gear to be tested in a cantilevered manner. The support block also has one horizontal passage and a securing bolt extending through the passage. The securing bolt carries the gear, which is directly mounted onto a cylindrical portion of the bolt and secured by a nut element screwed onto a threaded portion of the same bolt. The clamping device of this solution also has a thin washer axially arranged between the gear and the nut element.

The clamping device of this test rig provides only for an axial positioning of the gear, without the need of axially tightening the gear, because the load is applied onto two adjacent teeth along a direction which is radial with respect to the axis of the bolt. In other words, no substantial torsional moments are applied on the gear during the test. On the other hand, in an embodiment a load is applied along a tangential direction onto a single tooth at a time, so as to have the opportunity to carry out a deterministic loading and a higher number of tests on the same gear. In this case, the solution of FIG. 2 of FR-A-2878330 would be unsatisfactory, because it can have a relatively high clearance between the bolt and the supporting block and cannot react to possible torsional moments.

Such clearance would obviously limit the possibility of performing the test.

To overcome these drawbacks, FR-A-2878330 teaches to use a counter reacting toothed pad, which is coupled to the single support block and interacts with the gear to counteract against the force applied by the actuator. However, it is not to use the counter reacting toothed pad, because it involves a higher number of parts in the clamping device and damages two teeth per test.

### BRIEF DESCRIPTION

It is therefore an object of the present invention to provide a test apparatus to overcome, in a straightforward and low-cost manner, the aforementioned drawbacks.

According to the present invention, there is provided a test apparatus as claimed in claim 1.

### BRIEF DESCRIPTION OF THE DRAWINGS

One non-limiting embodiment of the present invention will be described by way of example with reference to the accompanying drawings, in which:

FIG. 1 shows a perspective view of a test rig having an embodiment of the test apparatus according to the present invention, with parts removed for clarity;

FIG. 2 shows a perspective view of another side of the test apparatus of FIG. 1, with parts removed for clarity;

FIG. 3 shows a sectioned perspective view of a detail of the test apparatus of FIG. 2; and

FIG. 4 shows a sectioned view along plane IV of FIG. 2 of the same detail of FIG. 3.

### DETAILED DESCRIPTION

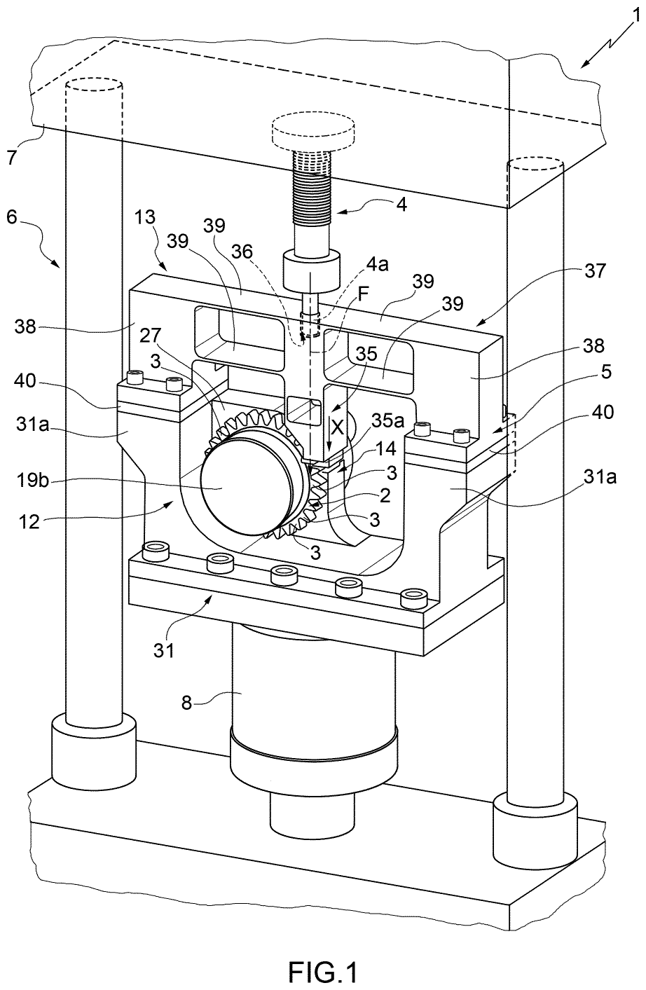

Number 1 in FIG. 1 indicates, as a whole, a test rig for testing a gear 2 having a plurality of teeth 3, in particular for fatigue testing of gear 2.

Rig 1 comprises: an actuator 4 for generating a force along a force application axis F, in particular force application axis F having a vertical orientation; and a test apparatus 5 securing and clamping gear 2, coupled to actuator 4 and configured to transfer the force generated by actuator 4 onto the flank of a single tooth 3 of gear 2.

Rig 1 furthermore has a support structure 6 for carrying actuator 4 and test apparatus 5.

In particular, support structure 6 comprises an upper transversal bar 7 carrying actuator 4 and a base 8 supporting test apparatus 5.

With reference to FIGS. 1 to 4, apparatus 5 comprises:

a clamping device 12 clamping and securing gear 2 in a fixed position within apparatus 5; and
a force application frame 13 configured to transfer the force generated by actuator 4 towards the flank of the tooth 3 of gear 2.

In more detail, clamping device 12 comprises: a single support block 14 having one through passage 15 extending along an axis A, with an orientation that is transversal, in particular orthogonal, to axis F; and a shoulder 16 transversal to axis A and, in particular orthogonal to axis A and parallel to axis F; and a securing bolt 17 axially extending through passage 15, having a shoulder 18 and comprising a pin 19 and a tightening member 20 tightened on pin 19 so as to axially sandwich and clamp gear 2 in fixed position between shoulders 16 and 18.

More specifically, pin 19 has a threaded portion 19a axially protruding from passage 15, and tightening member 20 is defined by a nut element secured on threaded portion 19a.

Furthermore, support block 14 further comprises a fixed protrusion 24, in particular having a cylindrical outer surface 24a, axially projecting with respect to shoulder 16 and defining an axial end portion 15a of passage 15. Gear 2 is directly fitted onto outer surface 24a. Additionally, shoulder 18 is axially spaced apart from protrusion 24 so as to leave a gap allowing for transferring the axial clamping force only onto gear 2, and not onto protrusion 24.

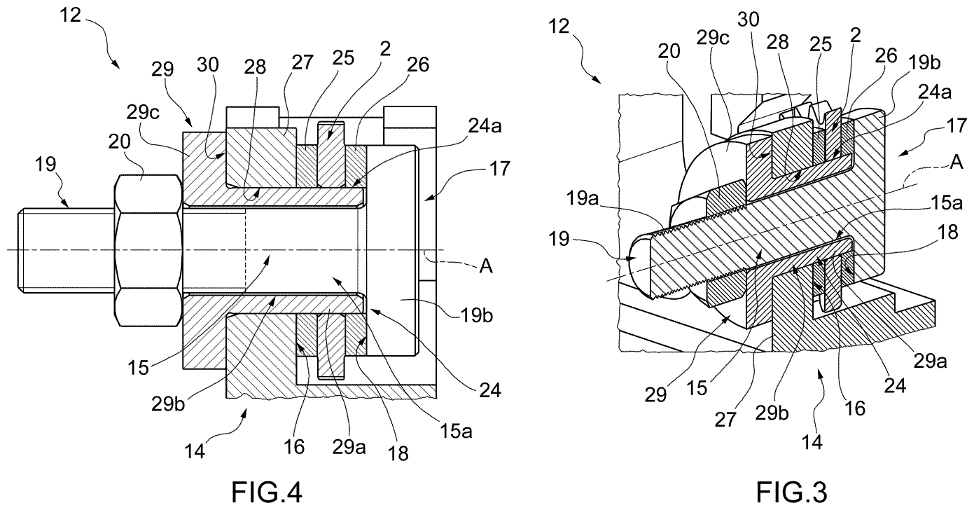

With particular reference to FIGS. 3 and 4, clamping device 12 further comprises a first and a second spacer element 25, 26, directly fitted onto outer surface 24a of protrusion 24 and arranged between shoulders 16 and 18. Spacer elements 25, 26 are arranged on the opposite sides of gear 2, so as to sandwich in between gear 2.

Furthermore, the axial thickness of spacer element 25 is identical to the axial thickness of spacer element 26, so as to avoid errors in positioning the spacer elements 25,26 during the operations carried out to mount gear 2 in clamping device 12. The axial thickness of spacer elements 25 and 26 depend on the axial thickness of gear 2 to be tested and is chosen during the mounting stage so as to align the tooth to be tested and center the axial position of such tooth with force application axis F.

In more detail, support block 14 comprises:

a single support plate 27, which projects in a fixed position transversally to axis A and substantially parallel to force application axis F, defines shoulder 16 and has a cylindrical seat 28, coaxial with passage 15 along axis A; and
a positioning pin 29 defining the whole passage 15 and comprising a hollow cylindrical portion 29b that engages seat 28 with an interference fit, so as to be fixed with respect to support plate 27.

In other words, the outer diameter of the portion 29b is equal to the diameter of seat 28, apart from the manufacturing tolerances that have to ensure the interference coupling.

Additionally, an end portion 29a of positioning pin 29 defines protrusion 24. Positioning pin 29 further comprises a flange 29c. Flange 29c axially rests onto a contact surface 30 of support block 14 axially opposite of shoulder 16 and provided on support plate 27.

In particular, positioning pin 29 is mounted into seat 28 by means of a press fit, so as to axially insert cylindrical portion 29b into seat 28 until flange 29c comes into axial contact with surface 30.

In particular, tightening member 20 axially and directly rests onto flange 29c. In the meantime, pin 19 comprises a head 19b axially and directly resting onto spacer element 26 and defining shoulder 18.

According to a variant (not shown), the positions of head 19b and tightening member 20 is inverted, so that shoulder 18 is defined by tightening member 20. According to another variant, shoulder 18 is defined by a further tightening member, in particular a further nut element which is tightened on a threaded portion of pin 19, at the axial end opposite to tightening member 20.

In the embodiment that is shown in the attached drawings, it is clear that protrusion 24 and shoulder 16 are defined by two distinct work pieces, i.e. pin 29 and support plate 27, so as to simplify the manufacturing operations for obtaining support block 14.

As an alternative (not shown), support plate 27 and protrusion 24 are provided as a single work piece, without the need of press coupling operations.

Overall, shoulder 18 is in contact with spacer element 26, spacer element 26 is in contact with gear 2 from a first side of gear 2, spacer element 25 is in contact from a second side of gear 2 opposite of the first side, spacer element 25 is also in contact with shoulder 16: friction between these contact areas defines the axial and angular retention of the gear 2. Such friction is a function of the axial load exerted by the tightening member 20, which in turn is a function of the driving torque of tightening member 20.

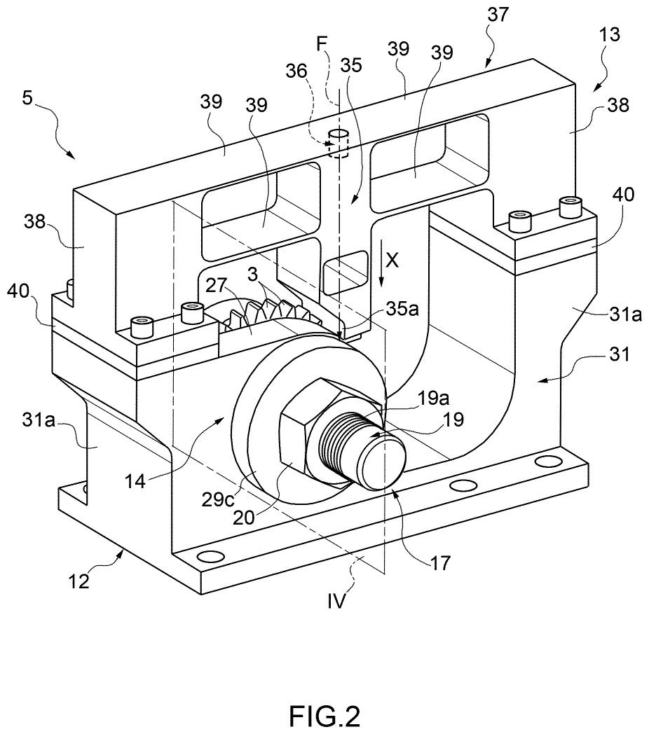

Further on, with particular reference to FIGS. 1 and 2, support block 14 defines part of a support frame 31, which, in more detail, is fixed on base 8.

Furthermore, force application frame 13 comprises a single force application column 35, which is aligned with actuator 4 and is elongated along force application axis F. Furthermore, column 35 is adapted to interact with the flank of the single tooth 3 of gear 2 for applying the force exerted by actuator 4 on the flank of the tooth 3. In particular, column 35 ends with an engagement body 35a facing the flank of the tooth 3 along a direction X coincident or parallel to force application axis F.

Column 35 is orthogonal and radially spaced apart with respect to axis A. Accordingly, force application axis F and direction X are orthogonal and radially spaced apart with respect to axis A.

Column 35 is moveable along force application axis F with respect to clamping device 12 under the action of actuator 4 and exerts the force onto the flank of the tooth along direction X.

In further detail, column 35 is coupled to actuator 4. In particular, column 35 comprises a recess 36 receiving an axially moveable section 4a of actuator 4.

Additionally, force application frame 13 has a carrier structure 37 moveably carrying column 35.

Carrier structure 37 comprises two lateral supporting pillars 38 and at least two, in the specific example shown four, flexible connecting arms 39. Connecting arms 39 connect column 35 to pillars 38 and allow for movement of column 35 along force application axis F, as they have a lower rigidity along axis F than in transversal directions (e.g. horizontal directions). In particular, arms 39 are designed as respective plates, extending transversally to axis F and elastically deflecting upon exertion of the force by actuator 4 on column 35. Such plates are arranged perpendicular to pillars 38 when being in a rest configuration at which actuator 4 is inactive; i.e. in the case no force is exerted on column 35.

Carrier structure 37 is fixed to support frame 31, particularly to two lateral support beams 31a of support frame 31.

Apparatus 5 also comprises at least two spacer elements 40, which are arranged between carrier structure 37 and support frame 31 and can be replaced by different spacer elements to define the distance of engagement body 35a from the flank of tooth 3, prior to the exertion of the force. In particular, each distancing element 40 is arranged between one respective support beam 31a and one respective pillar 38.

In this way, apparatus 5 can be setup to test gears 3 having same base diameter, but different number of teeth and/or to load the same tooth at different radii of the involute profile.

Apparatus 5 also comprises a sensor device (not shown) configured to determine the stress applied by column 35 on the flank of tooth 3. In particular, the sensor device comprises a plurality of strain gauges positioned on column 35 and/or on arms 39 so as to detect the deformation of such parts and therefore to determine the above-mentioned stress on the basis of such deformation. Additionally, actuator 4 is configured to provide for displaying the force generated by actuator 4 itself.

In use, prior to the testing, gear 2 is clamped and secured by clamping device 12. Possibly, even prior to the clamping of gear 2, distancing elements 40 are chosen for adjusting test apparatus 5 to the geometry of the gear 2 and to the position of the tooth 3 to be tested along direction X and axis F.

More specifically, gear 2 is fitted onto outer surface 24a of protrusion 24. Radial clearance between protrusion 24 and gear 2 is avoided because the diameter of surface 24a is set during the design stage so as to be substantially equal to the inner diameter of the gear 2. Thus, there is a very tight clearance enabling manual assembly and disassembly without introducing uncertainties in the location of the loaded point on the flank of tooth 3. Gear 2 is angularly and axially secured by tightening member 20 onto the pin 19, so as to sandwich and clamp gear 2 between shoulders 16 and 18.

In particular, on the basis of the axial width of the gear 2, prior to fitting gear 2 on outer surface 24a an appropriate spacer element 25 is fitted on outer surface 24a and after fitting gear 2 on outer surface 24a an appropriate spacer element 26 is fitted on outer surface 24a. This results in gear 2 being interposed between spacer elements 25 and 26. Then securing bolt 17 is inserted through passage 15 and the tightening element 20 is mounted onto pin 19 for securing and clamping gear 2. In particular, tightening member 20 is screwed onto threaded portion 19a.

Overall, gear 2 is clamped and secured by means of friction provided for by the contact of shoulder 16 with spacer element 25 and spacer element 25 with gear 2 and of the contact of shoulder 18 with spacer element 26 and of spacer element 26 with gear 2 and by the torque applied to securing bolt 17.

After the clamping of gear 2, the actual test of gear 2 is initiated. In particular, actuator 4 drives column 35 along axis F and column 35 transfers the force on the flank of the tooth 3 along direction X.

The test apparatus 5 according to the present invention are clear from the foregoing description.

Overall, test apparatus 5 allows clamping gear 2 in a manner to allow for obtaining absolute resistance values due to the absence of clearances in clamping device 12.

Indeed, gear 2 is clamped within clamping device 12 in a manner reducing the clearance of gear 2 with respect to the known clamping devices. Thanks to protruding portion 24, device 12 ensures that the axis of gear 2 is and remains coaxial to axis A, even during the application of force on the flank of tooth 3.

There are two distinct components, one, namely protrusion 24, ensuring that gear 2 remains coaxially arranged with axis A during the application of the force along force application axis F and one, namely securing bolt 17, exerting the retaining action on gear 2. This allows increasing the precision in positioning gear 2.

Furthermore, gear 2 and spacer elements 25 and 26 are directly fitted onto outer surface 24a, further reducing risks of clearance in radial direction.

Additionally, the number of components is limited, thereby reducing the overall complexity of test apparatus 5. As well, no counter acting toothed pads are needed to angularly lock the gear 2 during testing.

Furthermore, many teeth 3 can be tested on each gear 2, without using a tooth for counter reaction loading.

Clearly, changes may be made to test apparatus 5 as described herein without, however, departing from the scope of protection as defined in the accompanying claims.

What we claim is:

1. A test apparatus for testing a gear, the test apparatus comprising a clamping device for clamping the gear; the clamping device comprising:
a single support block having one passage extending along an axis (A) and a first shoulder transversal to said axis (A);
a securing bolt having a second shoulder and comprising a pin axially extending through the passage, and at least one tightening member designed to be tightened on the pin so as to axially clamp said gear between said first and second shoulder;
the test apparatus wherein said single support block comprises a protrusion axially projecting and fixed with respect to the first shoulder, defining an axial end portion of the passage and having an outer surface designed to carry the gear; said second shoulder being axially spaced apart from said protrusion.

2. The test apparatus according to claim 1, wherein the single support block comprises:
a support plate defining the first shoulder and having a seat; and
a positioning pin defining the passage and engaging said seat with an interference fit;
an end portion of said positioning pin defining said protrusion.

3. The test apparatus according to claim 2, wherein the single support block comprises a contact surface axially opposite of the first shoulder, and the positioning pin has a flange in axial contact with said contact surface.

4. The test apparatus according to claim 1, wherein the first shoulder and the protrusion are provided as a single work piece.

5. The test apparatus according to claim 1, wherein the protrusion has a cylindrical outer surfaces.

6. The test apparatus according to claim 1 wherein by further comprising a first and a second spacer element, each one being fitted on the outer surface of the protrusion and being axially arranged, in use, between the gear and respectively said first and the second shoulder.

7. The test apparatus according to claim 6, wherein the axial sizes of the first and the second spacer element are identical.

8. The test apparatus according to claim 1, wherein the pin of the securing bolt has a threaded portion and the tightening member is defined by a nut element tightened onto the threaded portion.

9. The test apparatus according to claim 1, wherein by comprising a single force application column elongated along a force application axis, which is orthogonal and radially spaced apart from said axis (A).

10. Test rig for testing a gear, the test rig comprising:
a fixed support structure;
an actuator carried by said support structure and controlled for generating a force, to be applied onto the flank of a tooth of the gear; and
a test apparatus according to claim 1, carried by said support structure and coupled to said actuator.
